(19) United States
(12) Patent Application Publication
(10) Pub. No.: US 2007/0173337 A1
(43) Pub. Date: Jul. 26, 2007

(54) Rolling boot assembly

(76) Inventors: Hans Wormsbaecher, Lake Orion, MI (US); Eric LaMothe, Clinton Township, MI (US)

Correspondence Address: GKN DRIVELINE NORTH AMERICA, INC, 3300 UNIVERSITY DRIVE, AUBURN HILLS, MI, 48326, US

(21) Appl. No.: 11/340,141

(22) Filed: Jan. 26, 2006

(51) Int. Cl. F16C 3/00

(52) U.S. Cl. 464/179

(57) ABSTRACT

A rolling boot assembly includes a shroud having a first portion and a second portion, and a radial boot having a first section and a second section. The second portion of the shroud has a free end. The first section of the radial boot is connected to the first portion of the shroud advantageously allowing the radial boot to roll axially toward the second portion of the shroud when the second section of the radial boot is selectively attached to a shaft or an inner joint part and the first portion of the shroud is selectively connected to an outer joint part. The second portion of the shroud remains unconnected. Also provided is a constant velocity joint assembly.

### TECHNICAL FIELD

The present invention relates generally to a rolling boot assembly for motor vehicle shaft joints, and more particularly concerns a reversed internal rolling radial boot assembly.

### BACKGROUND

Constant velocity joints connecting shafts to drive units are common components in automotive vehicles. The drive unit typically has an output shaft or an input shaft for receiving the joint. Typically, the drive unit is an axle, transfer case, transmission, power take-off unit or other torque device, all of which are common components in automotive vehicles. Typically, one or more joints are assembled to the shaft to form a propeller or drive shaft assembly. It is the propeller shaft assembly, which is connected, for instance, at one end to an output shaft of a transmission and, at the other end, to an input shaft of a differential. The shaft is solid or tubular with ends adapted to attach the shaft to an inner race of the joint thereby allowing an outer race connection to a drive unit. The inner race of the joint is typically press-fit, splined, or pinned to the shaft making the outer race of the joint available to be bolted or press-fit to a hub connector, flange or stubshaft of the particular drive unit. At the other end of the propeller shaft, the same typical or traditional connection is made to a second drive unit when connecting the shaft between the two drive units. Connecting the shaft to a drive unit via the constant velocity joint in this manner is considered a traditional connection. Direct torque flow (DTF) connection is a newer connection style that has advantages and improvements over the traditional connection. The constant velocity joint, whether a traditional or DTF connection, requires the internal cavity to be sealed from the external environment in which they are utilized, for example, by a J-boot or convoluted assembly.

The J-boot or internal radial diaphragm (IRD) boot provides a seal to prevent joint contamination or lubricant leakage. The IRD boot requires a first end of the boot to be crimped upon a cover that extends away from an outer joint part. The crimped connection may lead to leaks or other contamination of the joint due to a defective crimped seal between the first end of the boot and the cover. Moreover, the internal joint may be compromised should the cover become defective or the cover connection become compromised where it attaches to the outer joint part. In operation, the J-boot is sensitive to increased internal joint pressures, which may lead to bulging, kinking or binding of the boot.

It would be advantageous to have a roll boot assembly for use with a constant velocity joint that overcomes the limitations indicated above. A roll boot assembly is better suited for applications requiring higher joint articulations, plunging capability or high speeds.

### SUMMARY OF THE INVENTION

Accordingly, the present invention provides a roll boot assembly. The roll boot assembly minimizes sensitivity to increased internal joint pressure, thereby minimizing bulging, kinking or binding of the boot when in operation. In addition, the end portion of the boot is directly secured to the constant velocity joint by the cover thereby alleviating any crimp seal connection concerns.

A rolling boot assembly includes a shroud having a first, portion and a second portion, and a radial boot having a first section and a second section. The second portion of the shroud has a free end. The first section of the radial boot is connected to the first portion of the shroud advantageously allowing the radial boot to roll axially toward the second portion of the shroud when the second section of the radial boot is selectively attached to a shaft or an inner joint part and the first portion of the shroud is selectively connected to an outer joint part. The second portion of the shroud remains unconnected. Also provided is a constant velocity joint assembly. Four embodiments of the invention are described below.

The present invention is used with a constant velocity joint. The present invention is also used for a direct torque flow constant velocity joint.

The present invention will be best understood by reference to the following detailed description and taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows a plan view of an exemplary drive system for a typical four-wheel drive automobile wherein the present invention may be used to advantage.

FIG. 2 shows a first embodiment of an inventive boot assembly being used to advantage with a first constant velocity joint.

FIG. 3 shows a second embodiment of an inventive boot assembly being used to advantage with a second constant velocity joint.

FIG. 4 shows a third embodiment of an inventive boot assembly being used to advantage with a third constant velocity joint.

FIG. 5 shows a partial cross-sectional view of the third embodiment of the third constant velocity joint as shown in FIG. 4.

FIG. 6 shows a fourth embodiment of an inventive boot assembly being used to advantage with a fourth constant velocity joint.

FIG. 7 shows a cross sectional view of the fourth embodiment of the inventive boot assembly.

### DETAILED DESCRIPTION

In the following description, various operating parameters and components are described for one or more constructed embodiments. These specific parameters and components are included as examples and are not meant to be limiting.

While the invention is described with respect to a boot assembly for sealing a constant velocity joint for use in a vehicle, the following apparatus is capable of being adapted for various sealing purposes including automotive vehicle drive axles, motor systems that use a propeller shaft, or other vehicles and non-vehicle applications which require propeller shaft assemblies for torque transmission.

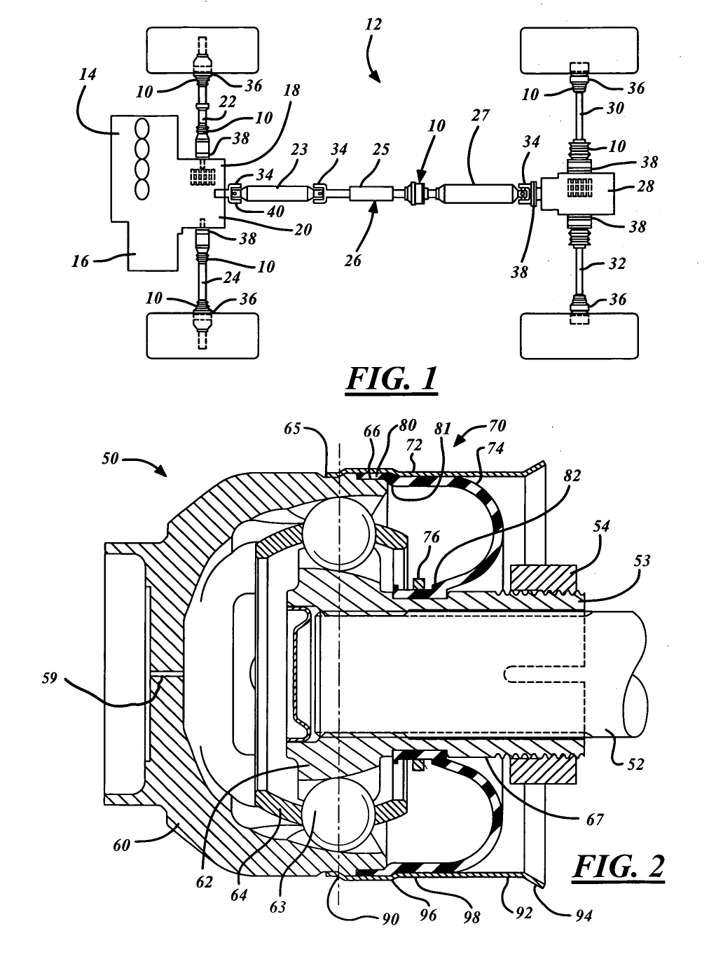

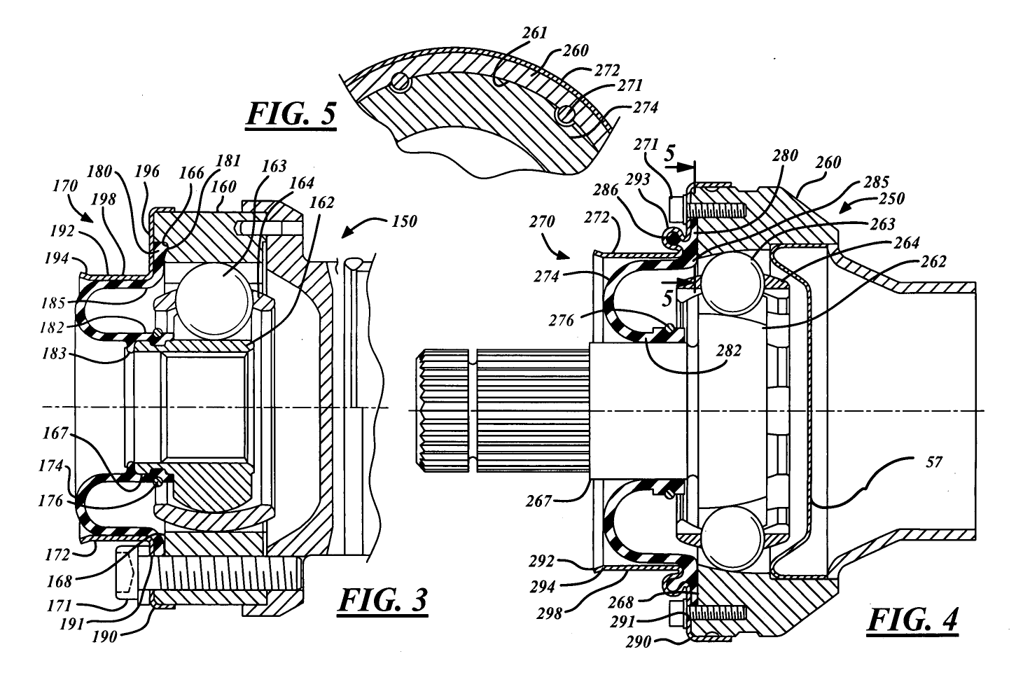

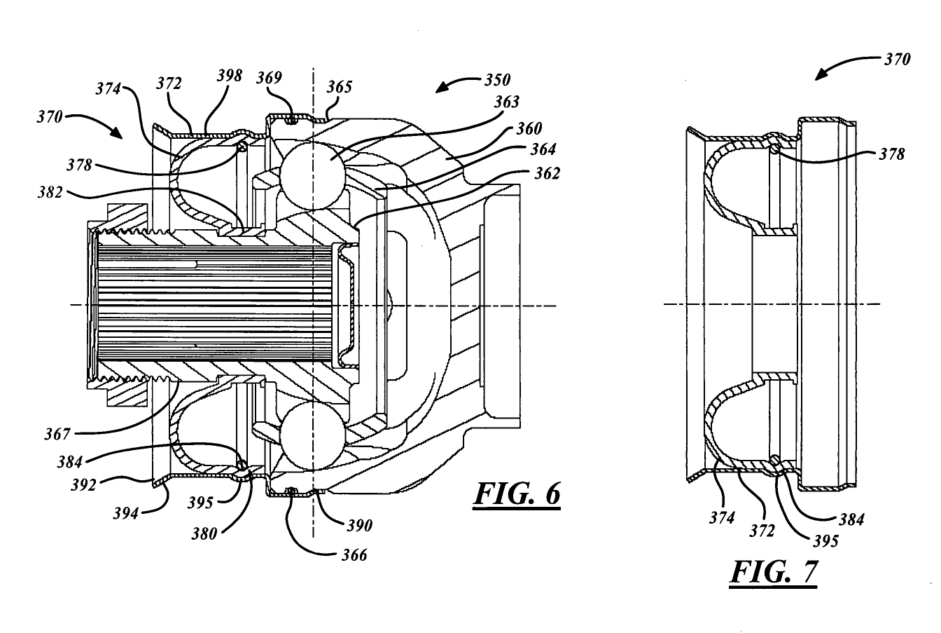

An exemplary drive system 12 for a typical four-wheel drive automobile is shown in FIG. 1. While a four-wheel drive system is shown and described, the concepts here presented could apply to a single drive unit system or multiple drive unit system, including rear wheel drive only vehicles, front wheel drive only vehicles, all wheel drive vehicles, and four wheel drive vehicles. In this example, the drive system 12 includes an engine 14 that is connected to a transmission 16 and a power take-off unit 18. A front differential 20 has a right hand side half shaft 22 and left hand side half shaft 24, each of which are connected to a wheel and deliver power to the wheels. On both ends of the right hand side half shaft 22 and left hand side half shaft 24 are constant velocity joints 10. A propeller shaft 26 connects the front differential 20 to a rear differential 28 wherein the rear differential 28 includes a rear right hand side shaft 30 and a rear left hand side shaft 32, each of which ends with a wheel on one end thereof. Constant velocity joints 10 are located on both ends of the half shafts 30, 32 that connect to the wheels and the rear differential 28. The propeller shaft 26, shown in FIG. 1, is a three-piece propeller shaft that includes a plurality of Cardan joints 34 and one high-speed constant velocity joint 10. The propeller shaft 26 includes interconnecting shafts 23, 25, 27. The constant velocity joints 10 transmit power to the wheels through the propeller shaft, 26 even if the wheels or the propeller shaft 26 have changed angles due to steering, raising, or lowering of the suspension of the vehicle. The constant velocity joints 10 may be any of the standard types known, such as a plunging tripod, a cross groove joint, a fixed ball joint, a fixed tripod joint, or a double offset joint, all of which are commonly known terms in the art for different varieties of constant velocity joints 10. The constant velocity joints 10 allow for transmission of constant velocities at angles typically encountered in every day driving of automotive vehicles, in both the half shafts, interconnecting shafts and propeller shafts of these vehicles. Optionally, each Cardan joint 34 may be replaced with any other suitable type of joint, including constant velocity joint types. The constant velocity joint (CVJ) having an inventive roll boot assembly in accordance with a second embodiment (FIG. 3) may be utilized to advantage for any of the above mentioned joint locations. The shafts 22, 23, 24, 25, 27, 30, 32 may be solid or tubular with ends adapted to attach each shaft to an inner race or an outer race of a joint in accordance with a traditional connection, thereby allowing the outer race or inner race to be connected to a hub connector 36, a flange 38 or stubshaft 40 of each drive unit, as appropriate, for the particular application. Also, any of the traditional connections identified in FIG. 1 at 10 or 34 that connect to a drive unit may optionally be a direct torque flow constant velocity joint (DTF CVJ) having a roll boot assembly in accordance with a first embodiment (FIG. 2), a third embodiment (FIG. 4), or a fourth embodiment (FIG. 6) of the present invention.

For completeness of the description of the first, third and fourth embodiments of the present invention as given in FIGS. 2, 4 and 6, respectively, the term direct torque flow (DTF) connection refers to a connection from the inner race of a constant velocity joint (CVJ) to the shaft of a differential, transmission or transfer case, generally supplied by the customer. The connection typically is in the form of a spline because of its robust design features as understood by one skilled in the art. However, it is anticipated that other forms of connection are appropriate including fixed and releaseable connections between the inner race and the shaft. A mating key connection is just one example, without limitation, of a releaseable connector between the inner race and the shaft. Thus, a DTF connection refers to the inner race coupling to the shaft of a drive unit, such as a differential, transmission or transfer case without limitation, as opposed to the traditional connection mentioned above. The connection type may be divided into two styles of DTF connection types, i.e. direct or indirect, as described in U.S. patent application Ser. No. 11/288,466 incorporated by reference herein. The DTF direct connection utilizes an extension shaft on the inner joint part to provide a male connection to a drive unit, such as shown in FIG. 4. Whereas, the DTF indirect connection utilizes a female coupling on the inner joint part to provide a female connection to a shaft of a drive unit, such as shown in FIGS. 2 and 6.

Also, as used herein, a DTF connector refers to a joint coupled to a shaft, which forms a DTF shaft assembly. Only together with the shaft of a differential, for example, does a DTF connector combine to make a DTF connection. It is recognized that the shaft of the drive unit may include the shaft of any input or output drive unit and is not necessarily limited to a shaft of a differential, transmission or transfer case.

FIGS. 2, 3, 4 and 6 will initially be described jointly below to the extent that their details generally correspond to one another. However, each of the constant velocity joints given in the various embodiments of the invention may have additional or different features recognized by a person of skill in the art. FIGS. 2, 3, 4 and 6 each show a CVJ 50, 150, 250, 350, respectively, for connection, but only FIG. 2 includes a journal shaft 52 of a drive unit (not shown) coupled to the CVJ 50 and axially retained by a compression nut 54 axially securing a collet 53 of the CVJ 50 thereto. Generally, each CVJ 50, 150, 250, 350 includes an outer joint part 60, 160, 260, 360, an inner joint part 62, 162, 262, 362 having an attachment surface 67, torque transmitting balls 63, 163, 263, 363, and a ball cage 64, 164, 264, 364, respectively. The balls 63, 163, 263, 363 are held in windows within the ball cage 64, 164, 264, 364, respectively. Also, each CVJ 50, 150, 250, 350 may utilize, to advantage, one of the inventive roll boot assembly 70, 170, 270, 370, respectively, to be described below. Before turning to the discussion of each inventive roll boot assembly, the representative constant velocity joint 50 given in FIG. 2 is first discussed.

The outer joint part 60 generally has a circumferential-shaped or semi-spherical bore therein and an outer surface. The outer joint part 60 is generally made of a steel material, however, it should be noted that any other type of metal material, hard ceramic, plastic, or composite material, etc. may also be used for the outer joint part 60. The material is required to be able to withstand the high speeds, temperatures and contact pressures required for the CVJ 50. The outer joint part 60 also includes a plurality of axially opposed ball tracks located on an inner surface thereof. The tracks generally form a spherical-shaped path within the inner surface of the outer joint part 60. The tracks are axially opposed such that one half of the ball tracks open to a side of the outer joint part 60 opposite to that of the other half of the ball tracks in any number of patterns. Optionally, for different types of CVJs, the ball tracks all may open or axially align on the same side of the outer race. Also, the ball tracks may be of a gothic or elliptical shape provided the pressure angle and conformity are maintained, or may be other shapes, as is understood by a person having skill in the art. Moreover, the ball tracks on the inner surface of the outer joint part 60 may also be double offset tracks. It should be noted that in the first embodiment as shown in FIG. 2 is a four plus four constant velocity joint, which has a total of eight balls in the CVJ 50. While the CVJ 50 first embodiment is a DTF CVJ having a fixed CVJ arrangement, any constant velocity joint type may be utilized. Further, it is recognized the CVJ may be a fixed or plunging CVJ, including without limitation a VL, RF, AC, DO, or tripod joints including other fixed or plunging CVJs. However, it should be noted that it is also contemplated that a joint may be made having any number of balls incorporating all of the features of the CVJ 50 according to the present invention.

The inner joint part 62 of the present embodiment generally has a circumferential shape. The inner joint part 62 is arranged within a bore of an outer joint part 60. The inner joint parts 62 includes an extension and an inner bore that is splined for axially retaining the CVJ in a rotationally fast way to a toothed or splined portion of a shaft 52. Rotational retention of the inner joint part 60 with a shaft 52 may be accomplished in other ways as would be recognized by a person of skill in the art. Axial retention of the inner joint part 62 with a shaft 52 is by way of a compression nut 54 on a collet connector 53. It is also recognized that axial retention of the inner joint part 62 with a shaft 52 may also be accomplished by a circlip, a spring clip, or a threaded fastener just to name a few examples, without limitation. An attachment or outer surface 67 of the inner joint part 62 includes a plurality of ball tracks that are axially opposed. The ball tracks generally have a spherical shape and are aligned with the ball tracks on the outer joint part 60 such that the axial angle will open in a similar or the same direction as the ball track directly aligned above it on the outer joint part 60. The ball tracks on the outer spherical surface of the inner joint part 62 have one half of the ball tracks axially oriented in one way while the other half of the ball tracks are axially oriented in the opposite direction. The ball tracks will open in an alternating pattern around the outer circumference of the inner joint part 62 in a matching relationship to that of the ball tracks of the outer joint part 60. It should be noted that in this embodiment the inner joint part 62 is made of steel, however, any other metal composite, hard plastic, ceramic, etc. may also be used.

The ball cage 64 generally has a ring-like appearance. The ball cage 64 is arranged within the bore of the outer joint part 60 such that it is not, in this embodiment, in contact with the inner surface of the outer joint part 60. The cage 64 has a plurality of oblong-shaped orifices or windows through a surface thereof. The number of windows may match the number of ball tracks on the outer joint part 60 and inner joint part 62 of the CVJ 50, which is eight windows therethrough in the present embodiment of the invention. The number of balls and windows may, however, differ. The cage 64 along with the inner joint part 62 are preferably made of a steel material but any other hard metal material, plastic, composite or ceramic, etc. may also be used.

The constant velocity joint 50 includes a plurality of balls 63. The balls 63 are each arranged within window of the cage 64 and within a ball track of the outer joint part 60 and of the inner joint part 62, respectively. More than one ball may be arranged within each of the windows or there may be no balls within a window. Therefore, the balls 63 will be capable of rolling in the axially opposed tracks aligned in the same direction.

The CVJ 50 may include a grease cap or barrier 57 on one end (FIG. 4). The barrier is generally made of a metal material, however, any plastic, rubber, ceramic or composite material may also be used. The barrier is press fit or integrally constructed between the outer joint part 60 and the propeller shaft or between the inner joint part 62 and a journal shaft 52. However, any other securing method known may also be used such as fasteners, bonding, etc. The barrier will insure the grease, which is used as a lubricant, will remain within the CVJ 50. Optionally, a vent port 59 (FIG. 2) may be placed through the barrier or the outer joint part 60 to relieve any internal pressure within the CVJ 50, and the vent port may include a valve.

While the first embodiment of the invention is described for a particular CVJ having balls and sets of ball tracks for a particular type of constant velocity joint motion, it is recognized that any other suitable constant velocity balls and sets of ball tracks may be utilized with the current invention to advantage. Moreover, the CVJ may also be of the fixed or plugging type of joint as is recognized within the art or may be a traditional CVJ or a DTF CVJ. Because CVJ's are well understood to a person of skill in the art, the CVJ's as given in the second, third and fourth embodiments are discussed below to the extent necessary to present the various embodiments of the invention.

FIG. 2 shows a first embodiment of an inventive boot assembly 70 being used to advantage with a first constant velocity joint 50. The boot assembly 70 includes a boot cover or shroud 72 and a reversed internal radius diaphragm or rolling radial boot 74 that advantageously rolls outwardly from an attached CVJ 50. The boot assembly 70 is connected to a CVJ 50 for providing a protective barrier for the internal parts and lubrication retention therein.

The boot 74 includes a compression or first section 80 at one end and an attachment or second section 82 at the other end. The first section 80 of the boot 74 is connected directly to the outer joint part 60 and further retained thereto by the shroud 72. Optionally, the first section 80 of the boot 74 is attached to the shroud 72, thereby being connectable, directly or indirectly, to the outer joint part 60. The second section 82 of the boot 74 is connected to an attachment surface 67 of an inner joint part 62 by resilient retention of the boot material, or by an optional retaining band or other fastener 76, and completes a sealed environment in the CVJ 50. The boot 74 may also include a compression lip 81 annularly extending around the first section 80 of the boot 74 to enhance the seal between the boot assembly 70 and the outer joint part 60.

The boot 74 may comprise any suitable material that is sufficiently flexible to allow the CVJ 50 to operate through a wide range of angles. Suitable materials include thermoplastic, rubber, silicone, plastic material and urethane, etc. Advantageously, thermoplastic, rubber and silicone also provide good sealing properties for the boot 74.

The shroud 72 is generally annular having a compression or first portion 90 and a free or second portion 92 separated by a support portion 98 in the form of an axially extending flange. The first portion 90 is for annularly receiving a boot 74 and sealingly connecting it to a CVJ 50. In this embodiment, the first portion 90 is crimped within a circumferential channel 65 located in the exterior of the outer joint part 60 of the CVJ 50. Also, the first portion 90 may include a compression crease 96 that provides for an additional compressive retention of a compression lip 81 of the boot 74 against a recess 66 of the outer joint part 60 of the CVJ 50. The second portion 92 may also include an annular flare 94, which serves as protective device for deflecting outside debris while supporting and retaining the boot 74. Moreover, the support portion 98 stabilizes the reversed internal radius diaphragm or rolling radial boot 74 by radially retaining the boot within the shroud 72 when the CVJ 50 undergoes angular and cyclic gyrations during operation. Generally, the shroud 72 provides protection to the boot 74 by minimizing external impact from debris.

The support portion 98 of the shroud 72 supports and radially retains the boot 74 as it is received during all angular displacements caused by the CVJ 50, while the second portion 92 only supports and radially retains the boot 74 as it rolls onto the second portion 92 caused by large angular displacements of the CVJ 50. Specifically, the second portion 92 axially extends from the support portion 98 so that it is generally free of the boot 74. In this regard, as an example the boot 74 may proportionately roll onto and off of 30% of the second portion 92 during small angular displacements thereby leaving about 70% towards the free end of the second portion 92 capable of receiving the boot 74 during large displacement of the CVJ 50. It is recognized that the boot 74 may roll onto and off of up to nearly 100% of the second portion 92 without binding or otherwise compromising the boot. Moreover, the second portion 92 is not intended to be connected to any other structure, but is intended to have an open or free end, such as in the form of a cantilever. Primarily, it is the free or open end of the second portion 92 of the shroud 72 that provides shielding or barrier for the boot 74 from external debris.

The shroud 72 may be made from metal or other materials, including plastic, for example, that have a rigid quality when used as a substantially cylindrical shape. For the shroud 72 of the present embodiment, it is beneficial to use a suitable material in the compression or first portion 90 that is also deformable to provide the required retention force when crimping the assembly 70 to the CVJ 50.

FIG. 3 shows a second embodiment of an inventive boot assembly 170 being used to advantage with a second constant velocity joint 150. The boot assembly 170 includes a boot cover or shroud 172 and a reversed internal radius diaphragm or rolling radial boot 174 that advantageously rolls outwardly from an attached CVJ 150. The boot assembly 170 is connected to a CVJ 150 for providing a protective barrier for the internal parts and lubrication retention therein.

The boot 174 includes a compression or first section 180 at one end and an attachment or second section 182 at the other end. The first section 180 of the boot 174 extends radially outward at a conforming portion 185 in that the first section 180 of the boot 174 is compressively retained directly to a front face 168 of the outer joint part 160 by the shroud 172. Optionally, the boot 174 may be compressively retained in a recess or groove 166 located on the CVJ 150. The second section 182 of the boot 174 is connected to an attachment surface 167 of an inner joint part 162 by resilient retention of the boot material, or by an optional retaining ring or other fastener 176, and completes a sealed environment in the CVJ 150. The boot 174 may optionally include a compression lip 181 annularly extending around the first section 180 of the boot 174 to enhance the seal between the boot assembly 170 and the outer joint part 160. The compression lip 181 provides additional retention of the boot 174 within the groove 166 of the outer joint part 160 when compressively retained by the shroud 172. The second section 182 of the boot 174 may optionally include a lip seal 183 annularly extending inwardly over an inner bore of the inner joint part 162, thereby providing additional sealing to the CVJ 150 when installed on a shaft.

The shroud 172 is generally annular having first portion 190 and a free or second portion 192 separated by a support portion 198 in the form of an axially extending flange. The first portion 190 extends radially outward providing a compression surface 196 for compressing the first section 180 of the boot 174 against the CVJ 150. The first portion 190 radially receives and compresses the boot 174 to a CVJ 150 by the bolts or fasteners 171 passing through the holes 191 of the shroud 172. The first section 180 of the boot 174, in direct contact with the CVJ 150 and the shroud 172 provides a seal therebetween. The second portion 192 may also include an annular flare 194, which serves as a protective device for deflecting outside debris while supporting and retaining the boot 174. Moreover, the support portion 198 stabilizes the reversed internal radius diaphragm or rolling radial boot 174 by radially retaining the boot within the shroud 172 when the CVJ 150 undergoes angular and cyclic gyrations during operation. Generally, the shroud 172 provides protection to the boot 174 by minimizing external impact from debris.

The support portion 198 of the shroud 172 supports and radially retains the boot 174 as it is received during all angular displacements caused by the CVJ 150, while the second portion 192 only supports and radially retains the boot 174 as it rolls onto the second portion 192 caused by large angular displacements of the CVJ 150. Specifically, the second portion 192 axially extends from the support portion 198 so that it is generally free of the boot 174. In this regard, the boot 174 may proportionately roll onto and off of about 80% of the second portion 192 during small angular displacements thereby leaving about 20% towards the free end of the second portion 192 capable of receiving the boot 174 during large displacement of the CVJ 150. It is recognized that the boot 174 may roll onto and off of up to nearly 100% of the second portion 192 without binding or otherwise compromising the boot. Moreover, the second portion 192 is not intended to be connected to any other structure, but is intended to have an open or free end, such as in the form of a cantilever. Primarily, it is the free or open end of the second portion 192 of the shroud 172 that provides shielding or barrier for the boot 174 from external debris.

FIG. 4 shows a third embodiment of an inventive boot assembly 270 being used to advantage with a third constant velocity joint 250. The boot assembly 270 includes a boot cover or shroud 272 and an external radius diaphragm or rolling radial boot 274 that advantageously rolls outwardly from an attached CVJ 250. The boot assembly 270 is connected to a CVJ 250 for providing a protective barrier for the internal parts and lubrication retention therein.

The boot 274 includes a compression or first section 280 at one end and an attachment or second section 282 at the other end. The first section 280 of the boot 274 extends radially outward at a conforming portion 285, allowing the first section 280 of the boot 274 to be compressively retained directly to a front face 268 of the outer joint part by the shroud 272. The second section 282 of the boot 274 is connected to an attachment surface 267 of an inner joint part 262 by resilient retention of the boot material, or by an optional retaining ring or other fastener 276, and completes a sealed environment in the CVJ 250. The boot 274 may optionally include a retention eyelet 286 annularly extending around the first section 280 of the boot 274 to enhance retention of the boot 274 and boot assembly 270 when subjected to internal pressure build-up.

The shroud 272 is generally annular having first portion 290 and a free or second portion 292 separated by a support portion 298 in the form of an axially extending flange. The first portion 290 extends radially outward providing a compression surface for compressing the first section 280 of the boot 274 against the CVJ 250. The first portion 290 radially receives and sealingly retains the boot 274 to a CVJ 250 by the bolts or fasteners 271 passing through the holes 291 of the shroud 272. The first section 280 of the boot 274, in direct contact with the CVJ 250 and the shroud 272 provides a seal therebetween. The second portion 292 may also include an annular flare 294, which serves as a protective device for deflecting outside debris while supporting and retaining the boot 274. Moreover, the support portion 298 provides support for the external radius diaphragm or rolling radial boot 274 by radially supporting the boot within the shroud 272 when the CVJ 250 undergoes angular and cyclic gyrations during operation. Generally, the shroud 272 provides protection to the boot 274 by minimizing external impact from debris. Optionally, the first section 280 of the boot 274 may be retained to the boot assembly 270 by crimping an eyelet 286 in an annular crimp-ring 293 of the shroud 272, thereby reducing the attachment compression required to seal the boot assembly 270 to the CVJ 250.

The support portion 298 of the shroud 272 supports and radially retains the boot 274 as it is received during all angular displacements caused by the CVJ 250, while the second portion 292 only supports and radially retains the boot 274 as it rolls onto the second portion 292 caused by large angular displacements of the CVJ 250. Specifically, the second portion 292 axially extends from the support portion 298 so that it is generally free of the boot 274. In this regard, the boot 274 may proportionately roll onto and off of 50% of the second portion 292 during small angular displacements thereby leaving 50% towards the free end of the second portion 292 capable of receiving the boot 274 during large displacement of the CVJ 250 as an example. It is recognized that the boot 274 may roll onto and off of up to nearly 100% of the second portion 292 without binding or otherwise compromising the boot. Moreover, the second portion 292 is not intended to be connected to any other structure, but is intended to have an open or free end, such as in the form of a cantilever. Primarily, it is the free or open end of the second portion 292 of the shroud 272 that provides shielding or barrier for the boot 274 from external debris.

FIG. 5 shows a partial cross-sectional view of the third embodiment of the CVJ 250 as shown in FIG. 4. The front face 268 of the outer joint part 260 may include an offset or step 261 annularly extending around the CVJ 250, thereby providing for depth or compression control of the boot 274 when compressively retained by the bolts 271 attaching the shroud 272 to the outer joint part 260.

Simultaneous reference may now be made to FIGS. 6 and 7. FIG. 6 shows a fourth embodiment of an inventive boot assembly 370 being used to advantage with a fourth constant velocity joint 350. FIG. 7 shows a cross sectional view of the fourth embodiment of the inventive boot assembly 370.

The boot assembly 370 includes a boot cover or shroud 372 and a radius diaphragm or rolling radial boot 374 that advantageously rolls outwardly from an attached CVJ 350. The boot assembly 370 is connected to a CVJ 350 for providing a protective barrier for the internal parts and lubrication retention therein.

The boot 374 includes a first section 380 at one end and an attachment or second section 382 at the other end. The first section 380 of the boot 374 is attached to the shroud 372, thereby being indirectly connected to the outer joint part 360. The second section 382 of the boot 374 is connected to an attachment surface 367 of an inner joint part 362 by resilient retention of the boot material, or by an optional retaining band or other fastener, and completes a sealed environment in the CVJ 350. The boot 374 includes a boot bluge or upset 384 annularly extending around the first section 380 of the boot 374. The upset 384 facilitates retention of the boot 374 to the shroud 372 by a retention ring 378.

The shroud 372 is generally annular having a compression or first portion 390 and a free or second portion 392 separated by a support portion 398 in the form of an axially extending flange. The support portion 398 is for annularly receiving a boot 374 within a matching upset 395 and is retained by a retention or spring ring 378. The first portion 390 is crimped within a circumferential channel 365 located in the outer joint part 360 of the CVJ 350. Optionally, an annular recess or groove 366 may be provided in the CVJ 350 for receiving an o-ring or seal 369 between the boot assembly 370 and the CVJ 350. The second portion 392 may also include an annular flare 394, which serves as a protective device for deflecting outside debris while supporting and retaining the boot 374. Moreover, the support portion 398 stabilizes the radius diaphragm or rolling radial boot 374 by radially retaining the boot within the shroud 372 when the CVJ 350 undergoes angular and cyclic gyrations during operation. Generally, the shroud 372 provides protection to the boot 374 by minimizing external impact from debris.

The support portion 398 of the shroud 372 supports and radially retains the boot 374 as it is received during all angular displacements caused by the CVJ 350, while the second portion 392 only supports and radially retains the boot 374 as it rolls onto the second portion 392 caused by large angular displacements of the CVJ 350. Specifically, the second portion 392 axially extends from the support portion 398 so that it is generally free of the boot 374. In this regard, as an example, the boot 374 may proportionately roll onto and off of about 60% of the second portion 392 during small angular displacements thereby leaving about 40% towards the free end of the second portion 392 capable of receiving the boot 374 during large displacement of the CVJ 350. It is recognized that the boot 374 may roll onto and off of up to nearly 100% of the second portion 392 without binding or otherwise compromising the boot. Moreover, the second portion 392 is not intended to be connected to any other structure, but is intended to have an open or free end, such as in the form of a cantilever. Primarily, it is the free or open end of the second portion 392 of the shroud 372 that provides shielding or barrier for the boot 374 from external debris.

While the material, coupling and treatment of the some of CVJ parts have been discussed, appropriate selection for other parts would be well understood by a person of skill in the art.

From the foregoing, it can be seen that there has been brought to the art a new and improved rolling boot assembly. While the invention has been described in connection with one or more embodiments, it should be understood that the invention is not limited to those embodiments. On the contrary, the invention covers all alternatives, modifications, and equivalents as may be included within the spirit and scope of the appended claims.

What is claimed is:

1. A roll boot assembly comprising:
a shroud having a first portion and a second portion having a free end; and
a radial boot having first section and a second section, said first section coupled to said first portion of said shroud such that said radial boot rolls axially toward said free end of said second portion of said shroud,
wherein said second section of said radial boot is selectively attachable to seal a shaft or an inner joint part, and said first portion of said shroud is selectively connectable to an outer joint part and said free end remains unconnected.

2. The assembly of claim 1 wherein said shroud is substantially cylindrical in the form of an axially extending flange.

3. The assembly of claim 1 wherein said shroud further includes a support portion separating said first portion from said second portion, wherein said support portion radially retains said radial boot and said second portion proportionately receives said radial boot when articulately rotated with respect to said shroud.

4. The assembly of claim 3 wherein said roll boot is axially received onto or off of the first 30% of said second portion of said shroud when articulately rotated with respect to said shroud.

5. The assembly of claim 1 wherein said second portion includes an annular flare.

6. The assembly of claim 1 wherein said shroud substantially covers said radial boot.

7. The assembly of claim 1 wherein said first portion includes a crimp section for selective attachment to an outer joint part of a joint.

8. The assembly of claim 1 wherein said first portion of said shroud extends radially outward from a conforming portion of said first section of said radial boot extending radially outward.

9. The assembly of claim 1 wherein said first portion includes a plurality of holes for selective attachment to an outer joint part of a joint.

10. The assembly of claim 1 wherein said radial boot further includes an eyelet and said shroud further includes an annular crimp-ring, wherein said eyelet is retained by said crimp-ring.

11. The assembly of claim 1 further including a retention ring for radially securing said radial boot to said shroud.

12. The assembly of claim 11 wherein said retention ring is received in a matching upset annularly in said first section of said radial boot and said first portion of said shroud.

13. The assembly of claim 11 wherein said retention ring is a spring ring.

14. The assembly of claim 1 further including a fastener for securing said second section of said radial boot selectively to said shaft or said inner joint part.

15. The assembly of claim 1 wherein said radial boot is made from a flexible material and said shroud is made from metal.

16. The assembly of claim 1 wherein said radial boot further includes a compression lip and said shroud further includes a compression crease, wherein said compression crease compressively engages said compression lip when selectively coupled to an outer joint part of a joint.

17. The assembly of claim 1 wherein said radial boot further includes a seal annularly extending inwardly from said second section of said radial boot, wherein said seal provides additional sealing of said selectively attached shaft when said second portion is selectively secured to said inner joint part.

18. The assembly of claim 1 wherein said radial boot further includes a compression lip annularly extending around said first section, wherein said compression lip provides additional retention when selectively coupled to an outer joint part of a joint.

19. An assembly comprising: a constant velocity joint having an outer joint part and an inner joint part; and a boot assembly, said boot assembly comprising:
a shroud having a first portion and a second portion having an open end; and
a radial boot having first section and a second section, said first section coupled to said first portion of said shroud such that said radial boot rolls outwardly away from said constant velocity joint axially toward said open end of said second portion of said shroud,
wherein said second section of said boot assembly is coupled to said inner joint part, and said first portion of said shroud is coupled to said outer joint part and said open end remains unconnected.

20. The assembly of claim 19 wherein said first section of said radial boot is compressively retained between said first portion of said shroud and said outer joint part.

21. The assembly of claim 19 further including an o-ring seal, wherein said outer joint part further includes a circumferential channel and a recess for receiving said o-ring seal, wherein said o-ring seal sealingly engages said boot assembly crimped into said circumferential channel.

22. The assembly of claim 19 further including a plurality of bolts for securing said boot assembly to said constant velocity joint.

23. The assembly of claim 19 wherein said constant velocity joint is a direct torque flow constant velocity joint.
